(19) United States
(12) Patent Application Publication
(10) Pub. No.: US 2015/0277582 A1
(43) Pub. Date: Oct. 1, 2015

(54) INFORMATION PROCESSING METHOD AND ELECTRONIC DEVICE

(71) Applicant: LENOVO (BEIJING) LIMITED, Beijing (CN)

(72) Inventor: CHAO ZHANG, Beijing (CN)

(21) Appl. No.: 14/497,653

(22) Filed: Sep. 26, 2014

(30) Foreign Application Priority Data
Mar. 28, 2014 (CN) 201410123928.9

(51) Int. Cl. G06F 3/03; G06F 1/16

(52) U.S. Cl. CPC G06F 3/03; G06F 1/1652; G06F 1/1694

(57) ABSTRACT

An information processing method and an electronic device thereof are provided. The information processing method comprises: determining whether a state change of an electronic device meets a first preset condition, in the case that a display unit of the electronic device displays a first display content in a first display mode, the first display mode enables that the first display content viewed at a first side of the electronic device is consistent with display content sent by the electronic device to the display unit; and displaying the first display content in a second display mode if the state change meets the first preset condition, the second display mode is different from the first display mode, and the second display mode enables that the first display content viewed at a second side of the electronic device is consistent with display content sent by the electronic device to the display unit.

### TECHNICAL FIELD

The present disclosure relates to the field of electronic technique, in particular, to an information processing method and an electronic device.

### BACKGROUND

Nowadays, electronic devices (such as smart phone, tablet computer, etc.) have become an important part of people's life. A user may use an electronic device (such as smart phone, tablet computer, etc.) to read novels, listen to music, play games and the like in order to release the pressure due to the fast rhythm of the modern life.

However, the inventor of the present disclosure found at least the following technical problems during the implementation of the solutions of the embodiments of the present disclosure.

Taking a tablet computer with a touch screen display as an example, when a first user at the first side of the tablet computer is viewing the display content of the tablet computer, if the first user wants to show the display content of the tablet computer to a second user at the second side of the tablet computer (the first side and the second side are the opposite sides of the tablet computer), only if the first user accurately clicks, on the touch screen display, virtual buttons on the touch screen display many times (such as invoking a menu, selecting to adjust the display direction, determining the adjust angle for the display direction, etc.), the tablet computer is triggered to adjust the display direction of the display content from a first direction suitable for the first user at the first side to a second direction suitable for the second user at the second side, so as to facilitate the second user viewing the display content. As such, the procedure for triggering the tablet computer to adjust the display direction is complicated which wastes time of users and degrades user experience.

### SUMMARY

According to an aspect of the present disclosure, an information processing method is provided. The method comprises: determining whether a state change of an electronic device meets a first preset condition, in the case that a display unit of the electronic device displays a first display content in a first display mode, the first display mode enables that the first display content viewed at a first side of the electronic device is consistent with display content sent by the electronic device to the display unit; and displaying the first display content in a second display mode if the state change meets the first preset condition, the second display mode is different from the first display mode, and the second display mode enables that the first display content viewed at a second side of the electronic device is consistent with display content sent by the electronic device to the display unit.

Optionally, said determining whether a state change of an electronic device meets a first preset condition comprises: determining whether a distance change in a preset direction between a first area and a second area of the electronic device exceeds a preset threshold, the first area is an area different from the second area; determining that the state change meets the preset condition, in the case that the distance change between the first area and the second area exceeds the preset threshold.

Optionally, said determining whether the distance change between a first area and a second area of the electronic device exceeds a preset threshold comprises: determining whether the distance change between the first area and the second area exceeds a first preset threshold in a first direction perpendicular to the plane where the display unit is located; or determining whether the distance change between the first area and the second area exceeds a second preset threshold in a second direction within the plane where the display unit is located.

Optionally, said determining whether the distance change between the first area and the second area exceeds a first preset threshold in a first direction perpendicular to the plane where the display unit is located comprises: determining whether a curved surface is formed at the electronic device responsive to the state change, and whether radian of the curved surface is greater than a first value corresponding to the first preset threshold, the curved surface is the plane where the display unit is located, the first area is an area at the border of the curved surface, and the second area is an area in the center of the curved surface.

Optionally, said determining whether the distance change between the first area and the second area exceeds a second preset threshold in a second direction within the plane where the display unit is located comprises: determining whether the extent of shrinking/stretching of a first edge of the electronic device is greater than the extent of shrinking/stretching of a second edge opposite to the first edge, and value of the shrinking/stretching of the first edge is greater than a second value corresponding to the second preset threshold, the first edge and the second edge are edges of the surface where the display unit is located, the first area is an area located at a first end of the first edge, and the second area is an area located at a second end of the first edge opposite to the first end.

Optionally, said determining whether the distance change between the first area and the second area exceeds a second preset threshold in a second direction within the plane where the display unit is located comprises: determining whether a first curved edge is formed at a first edge of the electronic device responsive to the state change, and a first curvature of the first curved edge is greater than a third value corresponding to the second preset threshold, the first edge is a edge of the surface where the display unit is located, the first area is an area at the border of the first curved edge, and the second area is an area in the center of the first curved edge.

Optionally, said displaying the first display content in a second display mode if the state change meets the first preset condition comprises: adjusting display modes of the first display content from the first display mode to the second display mode, based on a direction of deformation corresponding to the state change.

Optionally, light transmittance of display area on the display unit exceeds a first threshold, and light transmittances of components disposed at the display unit are no less than the first threshold; and said adjusting display modes of the first display content from the first display mode to the second display mode comprises: adjusting, with respect to a first preset reference axis, display directions of the first display content from a first display direction to a second display direction which is rotated by 180° from the first display direction, in the case that a curved surface is formed at the electronic device in response to the state change, and outer surface of the curved surface protrudes toward the second side of the electronic device.

Optionally, said adjusting display modes of the first display content from the first display mode to the second display mode based on a direction of deformation corresponding to the state change comprises: displaying the first display content on a second display subunit in a second display direction which is rotated by 180° from a first display direction corresponding to a first display subunit, in the case that a curved surface is formed at the electronic device responsive to the state change, a first direction of deformation associated with display plane of the first display subunit is opposite to a second direction of deformation associated with display plane of the second display subunit, and the outer surface of the curved surface protrudes toward the second side; the first display subunit displays the first display content on a first surface of the electronic device, the second display subunit displays the first display content in a second surface of the electronic device, the first surface is opposite to the second surface.

Optionally, said adjusting display modes of the first display content from the first display mode to the second display mode based on a direction of deformation comprises: adjusting, with respect to a second preset reference axis perpendicular to the plane where the display unit is located, display directions of the first display content from a first display direction to a second display direction which is rotated by 180° from the first display direction, in the case that the electronic device is deformed responsive to the state change, extent of shrinking/stretching of a first edge of the electronic device is greater than that of a second edge opposite to the first edge, and the first edge is located at the first side or the second side of the electronic device; or in the case that the electronic device is deformed responsive to the state change, a first curved edge is formed at a first edge of the electronic device, and the first curved edge protrudes toward the second side of the electronic device.

According to another aspect of the present disclosure, an electronic device is provided. The electronic device comprises: a body; a display unit arranged on the body, the display unit forms a first deformation in the case that the electronic device is in a first state, forms a second deformation in the case that the electronic device is switched from the first state to a second state, the first state is different from the second state; and displays a display content to be viewed at a first side of the electronic device and displays a display content to be viewed at a second side of the electronic device, the first side is opposite to the second side; and a processing unit coupled to the display unit, the processing unit determines whether a state change of the electronic device meets a first preset condition in the case that the display unit displays a first display content in a first display mode, the first display mode enables that the first display content viewed at the first side is consistent with display content sent by the electronic device to the display unit; and controls the display unit to display the first display content in a second display mode in the case that the state change meets the first preset condition, the second display mode enables that the first display content viewed at the second side is consistent with the first display content sent by the electronic device to the display unit, the first display mode is different from the second display mode.

Optionally, the processing unit further determines whether a distance change in a preset direction between a first area and a second area of the electronic device exceeds a preset threshold, the first area is an area different from the second area; determines that the state change meets the preset condition, in the case that the distance change between the first area and the second area exceeds the preset threshold.

Optionally, the processing unit further determines whether the distance change between a first area and a second area exceeds a first preset threshold in a first direction perpendicular to the plane where the display unit is located; or determines whether the distance change between a first area and a second area exceeds a second preset threshold in a second direction within the plane where the display unit is located.

Optionally, the processing unit further determines whether a curved surface is formed at the electronic device responsive to the state change, and whether radian of the curved surface is greater than a first value corresponding to the first preset threshold, the curved surface is the plane where the display unit is located, the first area is an area at the border of the curved surface, and the second area is an area in the center of the curved surface; or determines whether the extent of shrinking/stretching of a first edge of the electronic device is greater than the extent of shrinking/stretching of a second edge opposite to the first edge, and value of the shrinking/stretching of the first edge is greater than a second value corresponding to the second preset threshold, the first edge and the second edge are edges of the surface where the display unit is located, the first area is an area located at a first end of the first edge, and the second area is an area located at a second end of the first edge opposite to the first end; or determines whether a first curved edge is formed at a first edge of the electronic device responsive to the state change, and a first curvature of the first curved edge is greater than a third value corresponding to the second preset threshold, the first edge is a edge of the surface where the display unit is located, the first area is an area at the border of the first curved edge, and the second area is an area in the center of the first curved edge.

Optionally, the processing unit further adjusts display modes of the first display content from the first display mode to the second display mode, based on a direction of deformation corresponding to the state change.

Optionally, light transmittance of display area on the display unit exceeds a first threshold, and light transmittances of components disposed at the display unit are no less than the first threshold. The processing unit further adjusts, with respect to a first preset reference axis, display directions of the first display content from a first display direction to a second display direction which is rotated by 180° from the first display direction, in the case that a curved surface is formed at the electronic device in response to the state change, and outer surface of the curved surface protrudes toward the second side of the electronic device.

Optionally, the display unit comprises a first display subunit arranged on the first surface of the electronic device; a second display subunit arranged on the second surface of the electronic device; the first surface is opposite to the second surface, the first display subunit is located at the same side of the electronic device as the first side, the second display subunit is located at the same side of the electronic device as the second side; the processing unit further displays the first display content on the second display subunit in a second display direction which is rotated by 180° from a first display direction corresponding to the first display subunit, in the case that a curved surface is formed at the electronic device responsive to the state change, a first direction of deformation associated with display plane of the first display subunit is opposite to a second direction of deformation associated with display plane of the second display subunit, and the outer surface of the curved surface protrudes toward the second side.

Optionally, the processing unit further adjusts, with respect to a second preset reference axis perpendicular to the plane where the display unit is located, display directions of the first display content from a first display direction to a second display direction which is rotated by 180° from the first display direction, in the case that the electronic device is deformed responsive to the state change, extent of shrinking/stretching of a first edge of the electronic device is greater than that of a second edge opposite to the first edge, and the first edge is located at the first side or the second side of the electronic device; or in the case that the electronic device is deformed responsive to the state change, a first curved edge is formed at a first edge of the electronic device, and the first curved edge protrudes toward the second side of the electronic device.

### BRIEF DESCRIPTION OF THE DRAWINGS

FIG. 1 is a flow for the information processing method according to an embodiment of the present disclosure;

FIGS. 2A and 2B are illustrative diagrams of two application scenes of the information processing method according to an embodiment of the present disclosure;

FIGS. 2C is an illustrative diagram for the display unit displaying the first display content by using different display content according to an embodiment of the present disclosure;

FIG. 3A is an illustration of a first case for determining whether the state change of the electronic device meets the first preset condition according to an embodiment of the present disclosure;

FIG. 3B is a first illustrative diagram of a second case for determining whether the state change of the electronic device meets the first preset condition according to an embodiment of the present disclosure;

FIG. 3C is a third illustrative diagram of a second case for determining whether the state change of the electronic device meets the first preset condition according to an embodiment of the present disclosure; and

FIG. 4 is a functional block diagram of the electronic device according to an embodiment of the present disclosure.

### DETAILED DESCRIPTION

Embodiments of the present disclosure simplify the procedure for triggering the tablet computer to adjust the display direction by providing an information processing method and an electronic device.

In order to simplify the procedure for adjusting the display direction of the display content of the electronic device (such as smart phone, tablet computer, etc), the general idea is as follows:

An embodiment of the present disclosure provides an information processing method. the method comprises:

determining whether the state change of the electronic device meets a first preset condition in the case that the display unit displays a first display content in a first display mode, the first display mode enabling the first display content viewed at the first side to be consistent with the first display content sent by the electronic device to the display unit; and

displaying the first display content in a second display mode if the state change meets the first preset condition so that the first display content viewed at the second side is consistent with the first display content sent by the electronic device to the display unit, the second display mode is different from the first display mode.

From the above, it can be seen that by employing the solution (determining whether the state change of the electronic device meets a first preset condition in the case that the display unit displays a first display content in a first display mode, the first display mode enabling the first display content viewed at the first side to be consistent with the first display content sent by the electronic device to the display unit; and displaying the first display content in a second display mode if the state change meets the first preset condition so that the first display content viewed at the second side is consistent with the first display content sent by the electronic device to the display unit, the second display mode is different from the first display mode), the electronic device does not need to adjust the display direction of the display content on the display unit only after obtaining accurate clicks of the user; instead, if the state change of the electronic device meets a first preset condition, the electronic device is enabled to adjust the display direction of the first display content so that the display unit of the electronic device can display the first display content to the second side in a positive direction; therefore, the procedure for triggering the tablet computer to adjust the display direction is simplified, which implement the technical effects of saving time of users and improving user experience.

In order to understand the above technical solution better, the above solution will be described below in detail, in connection with the figures and the particular implementations.

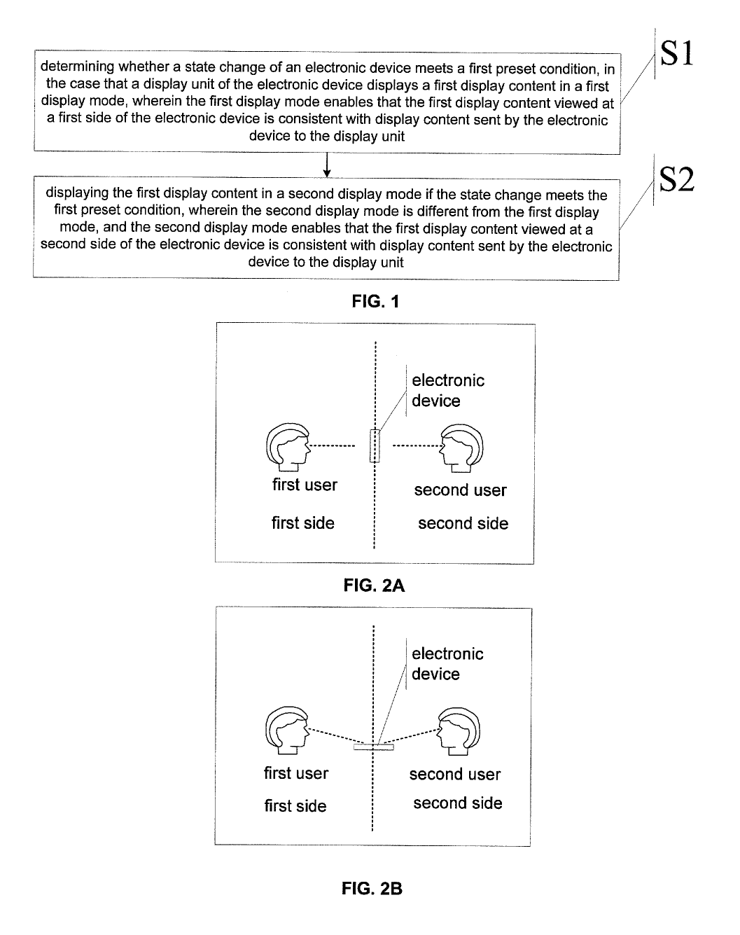

An embodiment of the present disclosure provides an information processing method. Referring to FIG. 1, it is a flow diagram of the information processing method according to an embodiment of the present disclosure. As shown by FIG. 1, the method comprises:

S1: determining whether the state change of the electronic device meets a first preset condition in the case that the display unit displays a first display content in a first display mode, the first display mode enabling the first display content viewed at the first side to be consistent with the first display content sent by the electronic device to the display unit;

S2: displaying the first display content in a second display mode if the state change meets the first preset condition so that the first display content viewed at the second side is consistent with the first display content sent by the electronic device to the display unit, the second display mode is different from the first display mode.

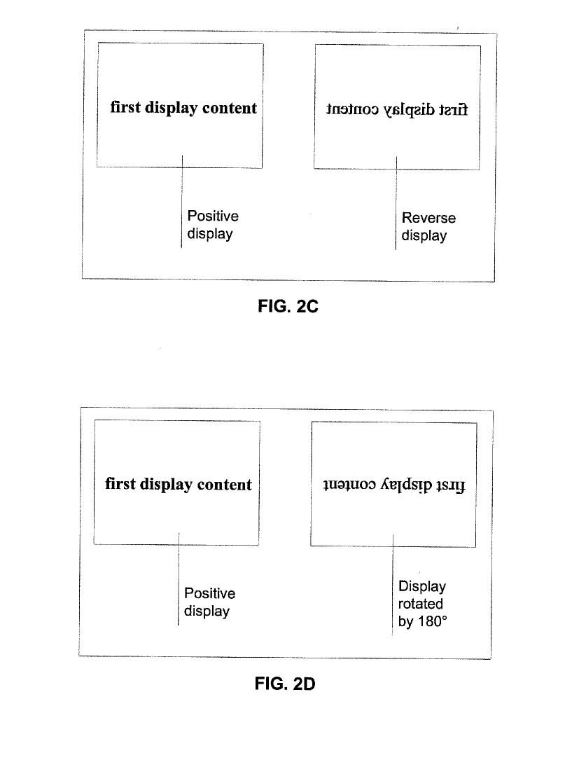

Referring to FIGS. 2A and 2B, they are illustrative diagrams of two application scenes of the information processing method according to an embodiment of the present disclosure. As shown by FIGS. 2A and 2B, a first user and a second user may view the display content, which is displayed on the display unit of the electronic device, from the first side and the second side of the electronic device, respectively. The first side and the second side are opposite sides of the electronic device.

In a practical application, the electronic device may be a smart phone, a tablet computer or a palm computer and so on, which is not limited thereto. The solution will be described in detail by embodying the electronic device as a tablet computer hereafter.

As shown in FIG. 2A, the first user may view the display content displayed on the display unit of the tablet computer from the first side of the tablet computer, while the second user may also view the display content displayed on the display unit of the tablet computer from the second side of the tablet computer. In a particular implementation, the display unit of the tablet computer may be a display screen with light transmission exceeding than a first threshold. The first threshold may be 30%, 50% and so on, which is not limited thereto. Meanwhile, there is no device with light transmission lower than the first threshold on the display unit. That is, other devices in the tablet computer do not affect the light transmission of the display unit.

As shown in FIG. 2A, in the case that the display unit with light transmission exceeding the first threshold displays the first display content in a first display mode, the first display mode enables the first display content viewed at the first side to be consistent with the first display content sent by the electronic device to the display unit. Referring to FIG. 2C, it is an illustrative diagram of the display unit displaying the first display content in a positive direction and in an inverse direction according to an embodiment of the present disclosure. That is, the display content viewed on the display unit of the tablet computer is consistent with the display content sent by the electronic device to the display unit, whereas the display content viewed at the second side is inverse to the display content sent by the electronic device to the display unit. It should be noted that the display content sent by the electronic device to the display unit, as stated herein, refers to the display content stored in the tablet computer and having an unadjusted display direction, which will not be explained hereafter. Taking the “first display content” as an example, continuing to refer to FIG. 2C, if the tablet computer sends to the display unit a display content with a positive display direction, the first user will view a positively displayed content as shown in FIG. 2C while the second user will view an inversely displayed content as shown in FIG. 2C.

As shown in FIG. 2B, the first user may view, at the first side of the tablet computer, the display content displayed on the display unit of the tablet computer, and the second user may also view, at the second side of the tablet computer, the display content displayed on the display unit of the tablet computer, in the case that the display unit displays the first display content in the first display mode, the content viewed by the first user is consistent with the content transmitted by a device of the tablet computer such as a graphic card, whereas the content viewed by the second user is reversed by 180° from the content transmitted by the device of the tablet computer such as a graphic card. Taking the “first display content” as an example, please refer to FIG. 2D which is an illustrative diagram of the display unit displaying the first display content in a positive direction and in an rotation direction according to an embodiment of the present disclosure. As shown in FIG. 2D, the content viewed by the first user is the first display content positively displayed as shown in FIG. 2D while the content viewed by the second user is the first display content displayed in the rotation direction as shown in FIG. 2D.

In the step S1, particularly, in the case that the tablet computer displays the first display content in the first display mode, referring to FIG. 2C, the display unit of the tablet computer displays to the first side the first display content in the first positive direction, then the first user at the first side can view the first display content displayed in a positive direction as shown in FIG. 2C while the second user at the second side can view the first display content displayed in a reverse direction as shown in FIG. 2C.

Determining whether the state change of the electronic device meets a first preset condition may comprises determining whether the distance change in a preset direction between a first area and a second area of the electronic device exceeds a preset threshold. One of ordinary skills in the art may configure suitable areas on the tablet computer as the first area and the second area respectively as required to meet the practical requirements, which will not be described in detail herein.

In the following, particular procedures for determining whether the state change of the electronic device meets a first preset condition will be described respectively in two cases.

The first case: determining whether the distance change between a first area and a second area exceeds a first preset threshold in a first direction perpendicular to the plane where the display unit is located.

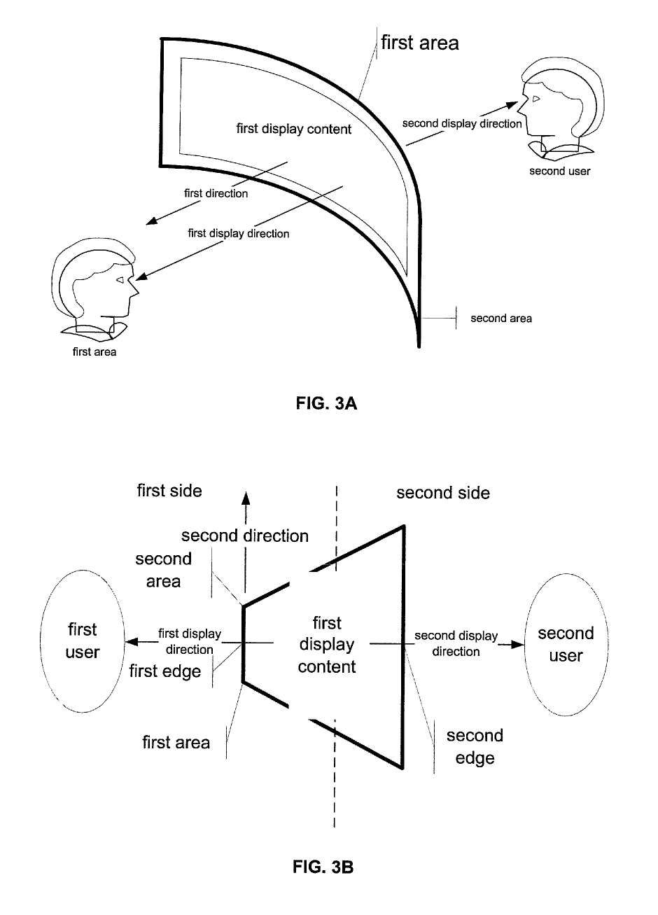

Particularly, referring to FIG. 3A which is an illustrative diagram of a first case for determining whether the state change of the electronic device meets the first preset condition according to an embodiment of the present disclosure, it is a side view. As shown in FIG. 3A, in the first case, determining whether the state change of the electronic device meets a first preset condition may be determining whether a curved surface is formed at the electronic device responsive to the state change and the radian corresponding to the curved surface is greater than a first value corresponding to the first preset threshold. At this time, the first area is an area at the border of the curved surface, while the second area is an area in the center of the curved surface. It should be noted that the first preset threshold corresponds to the radian of the curved surface. If the first preset threshold is small, it can be determined that the state change of the tablet computer meets a first preset condition even if the tablet computer forms a curved surface with a small radian responsive to the state change, while if the first preset threshold is large, it can be determined that the state change of the tablet computer meets a first preset condition only if the tablet computer forms a curved surface with a large radian responsive to the state change, which will not be described here. In a practical application, one of ordinary skills in the art may set the particular value of the first preset threshold as required to meet practical requirements, which will not be described here.

Of course, in a practical application, in addition to determining whether the state change of the electronic device meets a first preset condition according to the distance change between a first area and a second area in a first direction perpendicular to the plane where the display unit is located as stated above, whether the state change of the electronic device meets a first preset condition may be judged according to distance changes of a plurality of areas on the tablet computer in the first direction, which is of the similar principle as stated above and thus will not be described herein.

The second case: determining whether the distance change between a first area and a second area exceeds a second preset threshold in a second direction within the plane where the display unit is located.

The second case may be subdivided into the following two cases:

Firstly, referring to FIG. 3B which is a first illustrative diagram of a second case for determining whether the state change of the electronic device meets the first preset condition according to an embodiment of the present disclosure, it is a top view. As shown in FIG. 3B, in this case, determining whether the state change of the tablet computer meets a first preset condition may be determining whether the extent of shrinking/stretching of a first edge of the tablet computer is greater than the extent of shrinking/stretching of a second edge opposite to the first edge and the shrinking value/stretching value of the first edge is greater than a second value corresponding to the second preset threshold. In the case that the extent of shrinking/stretching of the first edge is greater than the extent of shrinking/stretching of the second edge, it can be determined that the state change of the tablet computer meets the first preset condition. As shown in FIG. 3B, the first edge and the second edge are edges of the surface where the display unit is located, the first area is an area located at a first end of the first edge, and the second area is an area located at a second end of the first edge opposite to the first end.

Referring to FIG. 3C which is a second illustrative diagram of a second case for determining whether the state change of the electronic device meets the first preset condition according to an embodiment of the present disclosure, it is a top view. As shown in FIG. 3C, in this case, determining whether the state change of the tablet computer meets a first preset condition may be determining whether a first curved edge is formed at the first edge of the electronic device responsive to the state change and a first curvature corresponding to the first curved edge is greater than a third value corresponding to the second preset threshold. In the case that a first curved edge is formed at the first edge responsive to the state change and a first curvature corresponding to the first curved edge is greater than a third value corresponding to the second preset threshold, it can be determined that the state change of the tablet computer meets a first preset condition. As shown in FIG. 3C, the first edge is an edge of the surface where the display unit is located, the first area is an area at the border of the first curved edge, and the second area is an area in the center of the first curved edge. Of course, as shown in FIG. 3C, in the case that a first curved edge is formed at the first edge responsive to the state change, the second edge opposite to the first edge may form a curved surface having a curving shape similar as that of the first curved edge. In a practical application, the second edge may also keep unchanged, which is not limited thereto.

From the description of the above two cases, it can be seen that the first area and the second area are two areas with motion trends in opposite directions. Therefore, in a particular implementation, one or more pressure fibers may be set in the corresponding areas of the tablet computer and the change of the motion trends between the first area and the second area of the tablet computer may be transformed into electronic signals by the pressure fibers, thereby it can be accurately judged whether the state change of the tablet computer meets the first preset condition, which will not be described in detail here.

If the state change of the tablet computer meets the first preset condition, the information processing method according to the embodiment of the present disclosure comes into step S2, i.e. displaying the first display content in a second display mode so that the first display content viewed at the second side is consistent with the first display content sent by the electronic device to the display unit, the second display mode is different from the first display mode.

In step S2, the display mode of the first display content may be adjusted from the first display mode to the second display mode, based on the deformation direction corresponding to the state change. Particularly, corresponding to the two cases for determining whether the state change of the tablet computer meets the first preset condition in the above step S1, adjusting the display direction of the first display content also correspondingly comprises two cases.

The first case: in the case that the tablet computer is deformed and a curved surface is formed responsive to the state change and the protruding direction of the outer surface of the curved surface points to the second side where the second user is located, adjusting, with respect to a first preset reference axis, the display direction of the first display content from the current first display direction to a second display direction which is reversed by 180° from the first display direction.

Returning back to FIG. 3A, in the case that the protruding direction of the outer surface of the curved surface of the tablet computer formed responsive to the state change points to the second side where the second user is located, adjusting, with respect to a first preset reference axis, the display direction of the first display content from the first display direction as shown in FIG. 3A to a second display direction which is reversed by 180° from the first display direction. The first preset reference axis is a reference axis parallel to both the left and right edges of the first display content and located in the middle of the display unit, that is, enabling the display unit to display to the second side the first display content in the second display mode, or put another way, enabling the first display content viewed at the second side to be consistent with the first display content sent by the tablet computer to the display unit.

The second case: in the case that the electronic device is deformed responsive to the state change so that the extent of shrinking/stretching of a first edge of the electronic device is greater than the extent of shrinking/stretching of a second edge opposite to the first edge, or in the case that the electronic device is deformed responsive to the state change so that a first curved edge is formed at the first edge of the electronic device responsive to the state change and the protruding direction of the first curved edge points to the second side, adjusting, with respect to a second preset reference axis perpendicular to the plane where the display unit is located, the display direction of the first display content from a first display direction to a second display direction which is rotated by 180° from the first display direction.

Returning back to FIG. 3B, in the case that the tablet computer is deformed responsive to the state change so that the extent of shrinking of the first edge of the tablet computer is greater than the extent of shrinking of the second edge opposite to the first edge, adjusting, with respect to the second preset reference axis, the display direction of the first display content from the current first display direction to a second display direction which is rotated by 180° from the first display direction. The second preset reference axis is the reference axis perpendicular to the plane where the display unit of the tablet computer is located and located in the middle of the display unit, enabling the display unit to display to the second side the first display content in a second positive direction, or said differently, enabling the first display content viewed at the second side to be consistent with the first display content sent by the tablet computer to the display unit.

Returning back to FIG. 3C, in the case that the electronic device is deformed responsive to the state change so that a first curved edge is formed at the first edge of the electronic device responsive to the state change and the protruding direction of the first curved edge points to the second side, adjusting, with respect to the second preset reference axis, the display direction of the first display content from the current first display direction to a second display direction which is rotated by 180° from the first display direction. The second preset reference axis is the reference axis perpendicular to the plane where the display unit of the tablet computer is located and located in the middle of the display unit, that is, enabling the display unit to display to the second side the first display content in a second positive direction, or put another way, enabling the first display content viewed at the second side to be consistent with the first display content sent by the tablet computer to the display unit.

From the viewpoint of a user, in the case that the first user located at the first side of the tablet computer wants to show the current display content to the second user located at the second side of the tablet computer, the first user or the second user only needs to trigger the state change of the tablet computer and makes the state change meet the first preset condition, so the second user is enabled to view the first display content in a positive direction, which simplifies the procedure for triggering the tablet computer to adjust the display direction, saves time of the users and thus improves user experience.

From the above steps, it can be seen that by employing the solution (determining whether the state change of the electronic device meets a first preset condition if it is determined that the display unit displays to the first side a first display content in a positive direction; and adjusting the display direction of the first display content if the state change meets the first preset condition so that the display unit displays the first display content to the second first side in a positive direction), the electronic device does not need to adjust the display direction of the display content on the display unit only after obtaining accurate clicks of the user. Instead, if the state change of the electronic device meets a first preset condition, the electronic device is enabled to adjust the display direction of the first display content so that the display unit of the electronic device can display the first display content to the second side in a positive direction. Therefore, the procedure for triggering the tablet computer to adjust the display direction is simplified, which achieves the technical effects of saving time of the users and improving user experience.

In a particular implementation, after the state change of the tablet computer meets the first preset condition and the first display content is displayed in the second mode, the tablet computer may revert the display direction of the first display content back to that before the display direction of the first display content is adjusted if the state change of the tablet computer does not meet the first preset condition (e.g. the tablet computer reverts from the state shown in FIG. 3A or 3B to the state shown in FIG. 2A or 2B). That is, in the case that the state of the tablet computer reverts to the previous state, the display direction of the first display content may also be converted to that before the display direction of the first display content is adjusted.

Of course, a time threshold (e.g. 3 seconds, 5 seconds, and so on) may be set. In the case that the duration of the state change of the tablet computer exceeds the time threshold, it means that the user wishes to adjust the display direction of the first display content, and thus the state after the display direction of the first display content is adjusted may be kept, which will not be described here.

Of course, in a practical application, except that the display unit of the tablet computer may be the display unit with light transmission exceeding the first threshold, the display unit may also be a display unit comprising two display subunits, the first display subunit is arranged on the first surface of the electronic device and the second display subunit is arranged on the second surface of the electronic device, the first surface and the second surface is opposite surfaces of the tablet computer, the first display subunit is located at the same side of the electronic device together with the first side, and the second display subunit is located at the same side of the electronic device together with the second side.

The particular procedure for determining whether the state change of the tablet computer meets the first preset condition in the case that the display unit comprises two display subunits has been described in detail, and thus will not be described again here.

If the state change of the tablet computer meets the first preset condition, in the first case shown in FIG. 3A, in the case that the tablet computer is deformed and a curved surface is formed responsive to the state change where the outer surface of the curved surface is the display plane of the second display subunit (i.e. the protruding direction of the outer surface of the curved surface points to the second side), a first deformation direction of the display plane of the first display subunit is opposite to a second deformation direction of the display plane of the second display subunit, the first display content may be displayed on the second display subunit in a second direction which is reversed by 180° from a first display direction corresponding to the first display subunit, so that the first display content viewed at the second side is consistent with the first display content sent by the tablet computer to the display unit.

In the second case shown in FIG. 3B, in the case that the electronic device is deformed responsive to the state change so that the extent of shrinking/stretching of the first edge of the electronic device is greater than the extent of shrinking/stretching of the second edge, similar to the case where the display unit is a display unit with light transmission exceeding the first threshold, the display direction of the first display content may be adjusted, with respect to a second preset reference axis perpendicular to the plane where the display unit is located, from a first display direction to a second display direction which is rotated by 180° from the first display direction. The second preset reference axis is the reference axis perpendicular to the plane where the display unit of the tablet computer is located and located in the middle of the display unit, that is, enabling the display unit to display to the second side the first display content in a second positive direction, or put another way, enabling the first display content viewed at the second side to be consistent with the first display content sent by the tablet computer to the display unit.

In the second case shown in FIG. 3C, in the case that the electronic device is deformed responsive to the state change so that a first curved edge is formed at the first edge of the electronic device responsive to the state change and the protruding direction of the first curved edge points to the second side, the display direction of the first display content may be adjusted, with respect to a second preset reference axis perpendicular to the plane where the display unit is located, from a first display direction to a second display direction which is rotated by 180° from the first display direction. The second preset reference axis is the reference axis perpendicular to the plane where the display unit of the tablet computer is located and located in the middle of the display unit, that is, enabling the display unit to display to the second side the first display content in a second positive direction, or put another way, enabling the first display content viewed at the second side to be consistent with the first display content sent by the tablet computer to the display unit, which will not be described here.

From the above, it can be seen that by employing the solution (determining whether the state change of the electronic device meets a first preset condition in the case that the display unit displays a first display content in a first display mode, the first display mode enables that the first display content viewed at the first side is consistent with the first display content sent by the electronic device to the display unit; and displaying the first display content in a second display mode if the state change meets the first preset condition so that the first display content viewed at the second side is consistent with the first display content sent by the electronic device to the display unit, the second display mode is different from the first display mode), the electronic device does not need to adjust the display direction of the display content on the display unit only after obtaining accurate clicks of the user. Instead, if the state change of the electronic device meets a first preset condition, the electronic device is enabled to adjust the display direction of the first display content so that the display unit of the electronic device can display the first display content to the second side in a positive direction. Therefore, the procedure for triggering the tablet computer to adjust the display direction is simplified, which achieves the technical effects of saving time of the users and improving user experience.

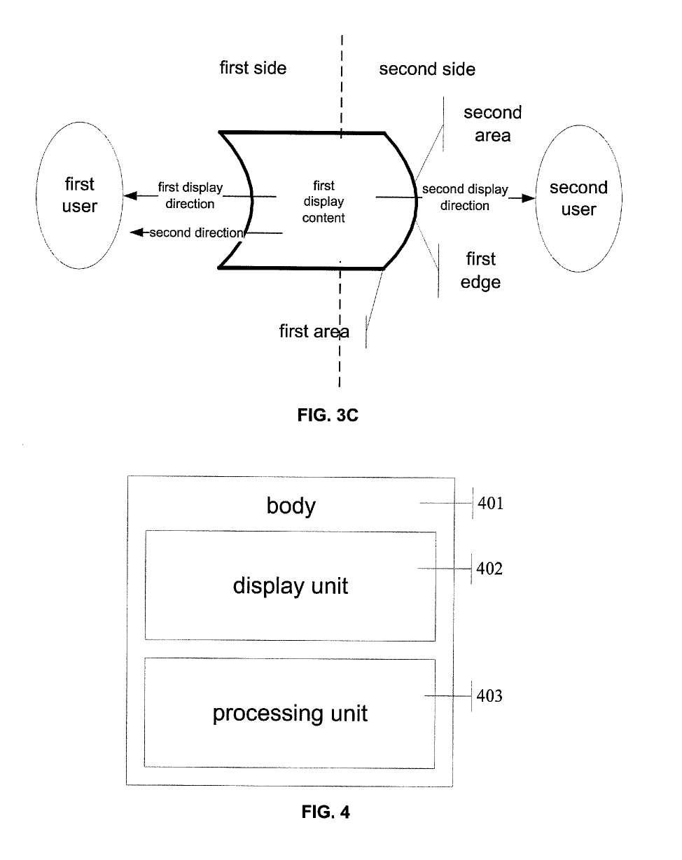

Based on the same inventive concept, an embodiment of the present disclosure also provides an electronic device having at least a first state and a second state. In a practical application, the electronic device may be a smart phone, a tablet computer or a palm computer, and so on. Referring to FIG. 4, it is a functional block diagram of the electronic device according to an embodiment of the present disclosure. As shown in FIG. 4, the electronic device comprises:

a body 401;

a display unit 402 arranged on the body 401, a first deformation being made to the display unit 402 in the case that the electronic device is in the first state, a second deformation being made to the display unit 402 in the case that the electronic device is switched from the first state to the second state, the first deformation being different from the second deformation, a user is able to view the display content displayed by the display unit 402 from a first side of the electronic device, and to view the display content displayed by the display unit 402 from a second side of the electronic device, the first side and the second side is the opposite sides of the electronic device; and

a processing unit 403 arranged in the body 401 and connected to the display unit 402, for determining whether the state change of the electronic device meets a first preset condition if the display unit displays a first display content in a first display mode, the first display mode enables that the first display content viewed at the first side is consistent with the first display content sent by the electronic device to the display unit; and for displaying the first display content in a second display mode if the state change meets the first preset condition so that the first display content viewed at the second side is consistent with the first display content sent by the electronic device to the display unit, the second display mode is different from the first display mode.

In a particular implementation, the processing unit 403 is used for determining whether the distance change in a preset direction between a first area and a second area of the electronic device exceeds a preset threshold, the first area is an area different from the second area, it is determined that the state change meets the preset condition if the distance change between the first area and the second area exceeds the preset threshold.

In a particular implementation, the processing unit 403 is used for determining whether the distance change between a first area and a second area exceeds a first preset threshold in a first direction perpendicular to the plane where the display unit 402 is located, or determining whether the distance change between a first area and a second area exceeds a second preset threshold in a second direction within the plane where the display unit 402 is located.

In a particular implementation, the processing unit 403 is used for: determining whether a curved surface is formed at the electronic device responsive to the state change and the radian of the curved surface is greater than a first value corresponding to the first preset threshold, the curved surface is the plane where the display unit is located, the first area is an area at the border of the curved surface, the first area is an area in the center of the curved surface; or determining whether the extent of shrinking/stretching of a first edge of the electronic device is greater than the extent of shrinking/stretching of a second edge opposite to the first edge and the shrinking value/stretching value of the first edge is greater than a second value corresponding to the second preset threshold, the first edge and the second edge are edges of the surface where the display unit is located, the first area is an area located at a first end of the first edge, the second area is an area located at a second end of the first edge opposite to the first end; or determining whether a first curved edge is formed at the first edge of the electronic device responsive to the state change and a first curvature corresponding to the first edge is greater than a third value corresponding to the second preset threshold, the first edge is a edge of the surface where the display unit is located, the first area is an area at the border of the first curved edge, the second area is an area in the center of the first curved edge.

In a particular implementation, the processing unit 403 is used for: adjusting the display mode of the first display content from the first display mode to the second display mode, based on the deformation direction corresponding to the state change. In a particular implementation, the electronic device may further comprise an image processing unit such as a graphic card. The processing unit 403 may adjust the display direction of the first display content based on the deformation direction corresponding to the state change and then transmit it to the image processing unit for sending directly by the image processing unit to the display unit for displaying, or may control the image processing unit to directly adjust the display direction of the first display content sent to the display unit, which will not be described here.

In a particular implementation, the light transmission of the display area on the display unit 402 exceeds a first threshold, and there is no device with light transmission lower than the first threshold arranged on the display unit 402, and the processing unit is used for: in the case that the electronic device is deformed and a curved surface is formed responsive to the state change and the protruding direction of the outer surface of the curved surface points to the second side, adjusting, with respect to a first preset reference axis, the display direction of the first display content from a first display direction to a second display direction which is reversed by 180° from the first display direction.

In a particular implementation, the display unit 402 comprises a first display subunit and a second display subunit, the first display subunit is arranged on the first surface of the electronic device and the second display subunit is arranged on the second surface of the electronic device, the first surface is opposite to the second surface, the first display subunit is located at the same side of the electronic device together with the first side, and the second display subunit is located at the same side of the electronic device together with the second side, the processing unit is used for: in the case that the electronic device is deformed and a curved surface is formed responsive to the state change, a first deformation direction of the display plane of the first display subunit is opposite to a second deformation direction of the display plane of the second display subunit, and the protruding direction of the outer surface of the curved surface points to the second side, displaying on the second display subunit 402 the first display content in a second direction which is reversed by 180° from a first display direction corresponding to the first display subunit.

In a particular implementation, the processing unit is used for: in the case that the electronic device is deformed responsive to the state change so that the extent of shrinking/stretching of a first edge of the electronic device is greater than the extent of shrinking/stretching of a second edge opposite to the first edge and the first edge is located at the first side or the second side, or in the case that the electronic device is deformed responsive to the state change so that a first curved edge is formed at the first edge of the electronic device responsive to the state change and the protruding direction of the first curved edge points to the second side, adjusting, with respect to a second preset reference axis perpendicular to the plane where the display unit 402 is located, the display direction of the first display content from a first display direction to a second display direction which is rotated by 180° from the first display direction.

The electronic device of this embodiment and the information processing method of the previous embodiment are two aspects of the same inventive concept. Because the implementation procedure of the method has been described in detail before, one of ordinary skills in the art may unambiguously know the structure and the implementation procedure of the electronic device of this embodiment according to the previously description, and thus will not be described in detail here for conciseness.

One or more of the solutions according to the embodiments of the present disclosure have at least the following technical effects or advantages:

By employing the solution (determining whether the state change of the electronic device meets a first preset condition if the display unit displays a first display content in a first display mode, the first display mode enabling the first display content viewed at the first side to be consistent with the first display content sent by the electronic device to the display unit; and displaying the first display content in a second display mode if the state change meets the first preset condition so that the first display content viewed at the second side is consistent with the first display content sent by the electronic device to the display unit, the second display mode is different from the first display mode), the electronic device does not need to adjust the display direction of the display content on the display unit only after obtaining accurate clicks of the user. Instead, if the state change of the electronic device meets a first preset condition, the electronic device is enabled to adjust the display direction of the first display content so that the display unit of the electronic device can display the first display content to the second side in a positive direction. Therefore, the procedure for triggering the tablet computer to adjust the display direction is simplified, which achieves the technical effects of saving time of the users and improving user experience.

Particularly, the computer program instructions corresponding to the information processing method of the embodiment of the present disclosure may be stored on a storage medium such as optical disc, hard disc, USB flash disc, and so on. When the computer program instructions in the storage medium which corresponds to the information processing method are read or executed by an electronic device, the following steps are performed:

determining whether the state change of the electronic device meets a first preset condition in the case that the display unit displays a first display content in a first display mode, the first display mode enabling the first display content viewed at the first side to be consistent with the first display content sent by the electronic device to the display unit;

displaying the first display content in a second display mode if the state change meets the first preset condition so that the first display content viewed at the second side is consistent with the first display content sent by the electronic device to the display unit, the second display mode is different from the first display mode.

Optionally, some other computer instructions are also stored in the storage medium. In a particular performance of corresponding computer instructions, determining whether the state change of the electronic device meets a first preset condition particularly comprises the following step:

determining whether the distance change in a preset direction between a first area and a second area of the electronic device exceeds a preset threshold, the first area being an area different from the second area, it is determined that the state change meets the preset condition if the distance change between the first area and the second area exceeds the preset threshold.

Optionally, some other computer instructions are also stored in the storage medium. In a particular performance of corresponding computer instructions, determining whether the distance change between a first area and a second area of the electronic device exceeds a preset threshold particularly comprises the following steps:

determining whether the distance change between a first area and a second area exceeds a first preset threshold in a first direction perpendicular to the plane where the display unit is located; or

determining whether the distance change between a first area and a second area exceeds a second preset threshold in a second direction within the plane where the display unit is located.

Optionally, some other computer instructions are also stored in the storage medium. In a particular performance of corresponding computer instructions, determining whether the distance change between a first area and a second area exceeds a first preset threshold in a first direction perpendicular to the plane where the display unit is located comprises the following step: determining whether a curved surface is formed at the electronic device responsive to the state change and the radian of the curved surface is greater than a first value corresponding to the first preset threshold, the curved surface is the plane where the display unit is located, the first area is an area at the border of the curved surface, and the second area is an area in the center of the curved surface.

In a particular performance of corresponding computer instructions, determining whether the distance change between a first area and a second area exceeds a second preset threshold in a second direction within the plane where the display unit is located particularly comprises the following steps: determining whether the extent of shrinking/stretching of a first edge of the electronic device is greater than the extent of shrinking/stretching of a second edge opposite to the first edge and the shrinking value/stretching value of the first edge is greater than a second value corresponding to the second preset threshold, the first edge and the second edge are edges of the surface where the display unit is located, the first area is an area located at a first end of the first edge, and the second area is an area located at a second end of the first edge opposite to the first end; or determining whether a first curved edge is formed at the first edge of the electronic device responsive to the state change and a first curvature corresponding to the first curved edge is greater than a third value corresponding to the second preset threshold, the first edge is a edge of the surface where the display unit is located, the first area is an area at the border of the first curved edge, and the second area is an area in the center of the first curved edge.

Optionally, some other computer instructions are also stored in the storage medium. In a particular performance of corresponding computer instructions, displaying the first display content in a second display mode if the state change meets the first preset condition comprises the following step:

adjusting the display mode of the first display content from the first display mode to the second display mode, based on the deformation direction corresponding to the state change.

Optionally, some other computer instructions are also stored in the storage medium. The light transmission of the display area on the display unit exceeds a first threshold, and there is no device with light transmission lower than the first threshold arranged on the display unit, in a particular performance of corresponding computer instructions, adjusting the display mode of the first display content from the first display mode to the second display mode comprises the following step:

in the case that the electronic device is deformed and a curved surface is formed responsive to the state change and the protruding direction of the outer surface of the curved surface points to the second side, adjusting, with respect to a first preset reference axis, the display direction of the first display content from a first display direction to a second display direction which is reversed by 180° from the first display direction.

Optionally, the display unit comprises a first display subunit and a second display subunit, the first display subunit is arranged on the first surface of the electronic device and the second display subunit is arranged on the second surface of the electronic device, the first surface is opposite to the second surface, the first display subunit is located at the same side of the electronic device together with the first side, the second display subunit is located at the same side of the electronic device together with the second side. Some other computer instructions are also stored in the storage medium. In a particular performance of corresponding computer instructions, adjusting the display mode of the first display content from the first display mode to the second display mode based on the deformation direction corresponding to the state change comprises the following step:

in the case that the electronic device is deformed and a curved surface is formed responsive to the state change, a first deformation direction of the display plane of the first display subunit is opposite to a second deformation direction of the display plane of the second display subunit, and the protruding direction of the outer surface of the curved surface points to the second side, displaying on the second display subunit the first display content in a second direction which is reversed by 180° from a first display direction corresponding to the first display subunit.

Optionally, in a particular performance of corresponding computer instructions, adjusting the display mode of the first display content from the first display mode to the second display mode based on the deformation direction corresponding to the state change comprises the following step:

in the case that the electronic device is deformed responsive to the state change so that the extent of shrinking/stretching of a first edge of the electronic device is greater than the extent of shrinking/stretching of a second edge opposite to the first edge and the first edge is located at the first side or the second side, or in the case that the electronic device is deformed responsive to the state change so that a first curved edge is formed at the first edge of the electronic device responsive to the state change and the protruding direction of the first curved edge points to the second side, adjusting, with respect to a second preset reference axis perpendicular to the plane where the display unit is located, the display direction of the first display content from a first display direction to a second display direction which is rotated by 180° from the first display direction.

One of ordinary skills in the art should understand that the embodiments of the present disclosure can be provided as methods, systems or computer program products. Accordingly, the present disclosure may take the form of full hardware embodiment, full software embodiment or embodiment combining software and hardware aspects. Furthermore, the present disclosure may take the form of computer program product implemented on one or more computer-usable storage mediums (comprising and not limited to magnetic disks, CD-ROM, optical memories, etc.) having computer-usable program code embodied thereon.

The present disclosure has been described referring to the flowcharts and/or block diagrams of the methods, the devices (systems), and the computer program products according to the embodiment of the present disclosure. It should be understood that each flow and/or block in the flowcharts and/or block diagrams, and the combination of the flows and/or blocks in the flowcharts and/or block diagrams may be implemented by computer program instructions. These computer program instructions may be provided to a general purpose computer, a special purpose computer, a embedded processor or processors of other programmable data processing devices to product a machine, so that the instructions executed by the computers or the processors of other programmable data processing devices produce an apparatus for implementing the functions specified in one or more flows in the flowcharts and/or one or more blocks in the block diagrams.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in one or more flows in the flowcharts and/or one or more blocks in the block diagrams.

The computer program instructions may also be loaded into a computer or other programmable data processing apparatus to cause a series of operational steps to be performed on the computer or other programmable apparatus to produce a computer implemented process such that the instructions which are executed on the computer or other programmable apparatus provide steps for implementing the function specified in one or more flows in the flowcharts and/or one or more blocks in the block diagrams.

Apparently, one of ordinary skills in the art can make alterations and modifications without departing from the spirit and scope of the present disclosure. As such, if these alterations and modifications of the present disclosure fall into the scope of the claims of the present disclosure and equivalents thereof, the present disclosure intends to contain these alterations and modifications.

1. An information processing method, comprising:
determining whether a state change of an electronic device meets a first preset condition, in the case that a display unit of the electronic device displays a first display content in a first display mode, wherein the first display mode enables that the first display content viewed at a first side of the electronic device is consistent with display content sent by the electronic device to the display unit; and
displaying the first display content in a second display mode if the state change meets the first preset condition, wherein the second display mode is different from the first display mode, and the second display mode enables that the first display content viewed at a second side of the electronic device is consistent with display content sent by the electronic device to the display unit.

2. The method of claim 1, wherein said determining whether a state change of an electronic device meets a first preset condition comprises:
determining whether a distance change in a preset direction between a first area and a second area of the electronic device exceeds a preset threshold, wherein the first area is an area different from the second area;
determining that the state change meets the preset condition, in the case that the distance change between the first area and the second area exceeds the preset threshold.

3. The method of claim 2, wherein said determining whether the distance change between a first area and a second area of the electronic device exceeds a preset threshold comprises:
determining whether the distance change between the first area and the second area exceeds a first preset threshold in a first direction perpendicular to the plane where the display unit is located; or
determining whether the distance change between the first area and the second area exceeds a second preset threshold in a second direction within the plane where the display unit is located.

4. The method of claim 3, wherein said determining whether the distance change between the first area and the second area exceeds a first preset threshold in a first direction perpendicular to the plane where the display unit is located comprises:
determining whether a curved surface is formed at the electronic device responsive to the state change, and whether radian of the curved surface is greater than a first value corresponding to the first preset threshold, wherein the curved surface is the plane where the display unit is located, the first area is an area at the border of the curved surface, and the second area is an area in the center of the curved surface.

5. The method of claim 3, wherein said determining whether the distance change between the first area and the second area exceeds a second preset threshold in a second direction within the plane where the display unit is located comprises:
determining whether the extent of shrinking/stretching of a first edge of the electronic device is greater than the extent of shrinking/stretching of a second edge opposite to the first edge, and value of the shrinking/stretching of the first edge is greater than a second value corresponding to the second preset threshold, wherein the first edge and the second edge are edges of the surface where the display unit is located, the first area is an area located at a first end of the first edge, and the second area is an area located at a second end of the first edge opposite to the first end.

6. The method of claim 3, wherein said determining whether the distance change between the first area and the second area exceeds a second preset threshold in a second direction within the plane where the display unit is located comprises:
determining whether a first curved edge is formed at a first edge of the electronic device responsive to the state change, and a first curvature of the first curved edge is greater than a third value corresponding to the second preset threshold, wherein the first edge is a edge of the surface where the display unit is located, the first area is an area at the border of the first curved edge, and the second area is an area in the center of the first curved edge.

7. The method of claim 1, wherein said displaying the first display content in a second display mode if the state change meets the first preset condition comprises:
adjusting display modes of the first display content from the first display mode to the second display mode, based on a direction of deformation corresponding to the state change.

8. The method of claim 7, wherein light transmittance of display area on the display unit exceeds a first threshold, and light transmittances of components disposed at the display unit are no less than the first threshold; and said adjusting display modes of the first display content from the first display mode to the second display mode comprises:
adjusting, with respect to a first preset reference axis, display directions of the first display content from a first display direction to a second display direction which is rotated by 180° from the first display direction, in the case that a curved surface is formed at the electronic device in response to the state change, and outer surface of the curved surface protrudes toward the second side of the electronic device.

9. The method of claim 7, wherein said adjusting display modes of the first display content from the first display mode to the second display mode based on a direction of deformation corresponding to the state change comprises:
displaying the first display content on a second display subunit in a second display direction which is rotated by 180° from a first display direction corresponding to a first display subunit, in the case that a curved surface is formed at the electronic device responsive to the state change, a first direction of deformation associated with display plane of the first display subunit is opposite to a second direction of deformation associated with display plane of the second display subunit, and the outer surface of the curved surface protrudes toward the second side;
wherein the first display subunit displays the first display content on a first surface of the electronic device, the second display subunit displays the first display content in a second surface of the electronic device, the first surface is opposite to the second surface.

10. The method of claim 7, wherein said adjusting display modes of the first display content from the first display mode to the second display mode based on a direction of deformation comprises:
adjusting, with respect to a second preset reference axis perpendicular to the plane where the display unit is located, display directions of the first display content from a first display direction to a second display direction which is rotated by 180° from the first display direction, in the case that the electronic device is deformed responsive to the state change, extent of shrinking/stretching of a first edge of the electronic device is greater than that of a second edge opposite to the first edge, and the first edge is located at the first side or the second side of the electronic device; or in the case that the electronic device is deformed responsive to the state change, a first curved edge is formed at a first edge of the electronic device, and the first curved edge protrudes toward the second side of the electronic device.

11. An electronic device, comprising:
a body;
a display unit arranged on the body, which:
forms a first deformation in the case that the electronic device is in a first state;
forms a second deformation in the case that the electronic device is switched from the first state to a second state, the first state is different from the second state; and
displays a display content to be viewed at a first side of the electronic device and displays a display content to be viewed at a second side of the electronic device, the first side is opposite to the second side; and
a processing unit coupled to the display unit, which:
determines whether a state change of the electronic device meets a first preset condition in the case that the display unit displays a first display content in a first display mode, wherein the first display mode enables that the first display content viewed at the first side is consistent with display content sent by the electronic device to the display unit; and
controls the display unit to display the first display content in a second display mode in the case that the state change meets the first preset condition, wherein the second display mode enables that the first display content viewed at the second side is consistent with the first display content sent by the electronic device to the display unit, the first display mode is different from the second display mode.

12. The electronic device of claim 11, wherein the processing unit further:
determines whether a distance change in a preset direction between a first area and a second area of the electronic device exceeds a preset threshold, wherein the first area is an area different from the second area;
determines that the state change meets the preset condition, in the case that the distance change between the first area and the second area exceeds the preset threshold.

13. The electronic device of claim 12, wherein the processing unit further:
determines whether the distance change between a first area and a second area exceeds a first preset threshold in a first direction perpendicular to the plane where the display unit is located; or
determines whether the distance change between a first area and a second area exceeds a second preset threshold in a second direction within the plane where the display unit is located.

14. The electronic device of claim 13, wherein the processing unit further:
determines whether a curved surface is formed at the electronic device responsive to the state change, and whether radian of the curved surface is greater than a first value corresponding to the first preset threshold, wherein the curved surface is the plane where the display unit is located, the first area is an area at the border of the curved surface, and the second area is an area in the center of the curved surface; or
determines whether the extent of shrinking/stretching of a first edge of the electronic device is greater than the extent of shrinking/stretching of a second edge opposite to the first edge, and value of the shrinking/stretching of the first edge is greater than a second value corresponding to the second preset threshold, wherein the first edge and the second edge are edges of the surface where the display unit is located, the first area is an area located at a first end of the first edge, and the second area is an area located at a second end of the first edge opposite to the first end; or
determines whether a first curved edge is formed at a first edge of the electronic device responsive to the state change, and a first curvature of the first curved edge is greater than a third value corresponding to the second preset threshold, wherein the first edge is a edge of the surface where the display unit is located, the first area is an area at the border of the first curved edge, and the second area is an area in the center of the first curved edge.

15. The electronic device of claim 11, wherein the processing unit further:
adjusts display modes of the first display content from the first display mode to the second display mode, based on a direction of deformation corresponding to the state change.

16. The electronic device of claim 15, wherein light transmittance of display area on the display unit exceeds a first threshold, and light transmittances of components disposed at the display unit are no less than the first threshold;, the processing unit further:
adjusts, with respect to a first preset reference axis, display directions of the first display content from a first display direction to a second display direction which is rotated by 180° from the first display direction, in the case that a curved surface is formed at the electronic device in response to the state change, and outer surface of the curved surface protrudes toward the second side of the electronic device.

17. The electronic device of claim 15, wherein the display unit comprises:
a first display subunit arranged on the first surface of the electronic device;
a second display subunit arranged on the second surface of the electronic device;
wherein the first surface is opposite to the second surface, the first display subunit is located at the same side of the electronic device as the first side, the second display subunit is located at the same side of the electronic device as the second side;
wherein the processing unit further:
displays the first display content on the second display subunit in a second display direction which is rotated by 180° from a first display direction corresponding to the first display subunit, in the case that a curved surface is formed at the electronic device responsive to the state change, a first direction of deformation associated with display plane of the first display subunit is opposite to a second direction of deformation associated with display plane of the second display subunit, and the outer surface of the curved surface protrudes toward the second side.

18. The electronic device of claim 15, wherein the processing unit further:
adjusts, with respect to a second preset reference axis perpendicular to the plane where the display unit is located, display directions of the first display content from a first display direction to a second display direction which is rotated by 180° from the first display direction, in the case that the electronic device is deformed responsive to the state change, extent of shrinking/stretching of a first edge of the electronic device is greater than that of a second edge opposite to the first edge, and the first edge is located at the first side or the second side of the electronic device; or in the case that the electronic device is deformed responsive to the state change, a first curved edge is formed at a first edge of the electronic device, and the first curved edge protrudes toward the second side of the electronic device.
